(19) United States
(12) Patent Application Publication
(10) Pub. No.: US 2004/0083469 A1
(43) Pub. Date: Apr. 29, 2004

(54) Method for updating firmware of optical disk system

(76) Inventors: Ping-Sheng Chen, Chia-Yi Hsien (TW); Hung-Cheng Kuo, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,482

(22) Filed: Oct. 23, 2002

(51) Int. Cl. G06F 9/44

(52) U.S. Cl. 717/168; 713/100; 717/174

(57) ABSTRACT

An update method is used in an optical disk system to update firmware information stored in a firmware memory. The method includes fetching program code and an update program routine from an update source, storing the program code into a first buffer, storing the update program routine into a second buffer, executing the update program routine stored in the second buffer, writing the program code stored in the first buffer into the firmware memory to update the firmware information, and changing a value of a program counter of the microprocessor such that the microprocessor executes the program code stored in the firmware memory at a predetermined location of the program code instead of executing a next instruction in the program code located after the current position of the program counter, and using the program code as updated firmware information to control the optical disk system.

### Background of Invention

1. Field of the Invention

The present invention relates to an optical disk system, and more specifically, to an improved method for updating firmware of the optical disk system.

2. Description of the Prior Art

Recently, optical disk systems have experienced a sharp rise in popularity. Due to the constant development of optical disk systems, improvements are constantly being made. However, these improvements are not limited only to new optical disk systems. It is sometimes possible to add features or improvements to an existing optical disk system through a firmware update. One such method for updating firmware in an optical disk system is disclosed by Hu in U.S. Pat. No. 6,170,043, entitled “Method for controlling an optic disk”. The prior art device is able to used updated firmware stored on either an optical disk or on a computer to update the firmware of the optical disk system.

Please refer to FIG. 1. FIG. 1 is a block diagram of an optical disk system and its periphery units according to the prior art. In FIG. 1, an optical disk system control chip 200 is used to update firmware information, which is stored in a memory 210, such as a flash memory 210 or an electrical erasable programmable ROM (EEPROM). The system control chip 200 includes an extra memory 202, such as a dynamic random access memory (DRAM), a microprocessor 204, a decoder 206, and a controller 208. The microprocessor 204 is separately coupled to the extra memory 202, the decoder 206, the controller 208, and the flash memory 210 so as to directly control the controller 208 and the decoder 206, and directly access the flash memory 210 and the extra memory 202. The decoder 206 and the controller 208 are also coupled together. The controller 208 is used to receive external control signals and information, such as control signals from a radio-frequency (RF) amplifier and controller 110 and information stored in an optical disk such as a digital versatile disk (DVD) or a compact disk (CD) 100 through the RF amplifier and controller 110. The decoder 206 is coupled to a buffer memory 212 external to the system control chip 200. The buffer memory 212 may be a DRAM and can communicate with a computer 216 through a main board interface 214. The main board interface 214 can be an IDE interface, an EIDE interface, a SCSI interface, an RS232 interface, a USB interface, or an IEEE 1394 interface.

When the optical disk system is operated in normal mode, in which there is no need to update firmware information, the microprocessor 204 reads information stored in the flash memory 210 through a data bus, which is schematically illustrated in FIG. 1 by the lines connecting each unit. The data bus provides the necessary couplings between each unit. In this normal mode, the flash memory 210 is used as a memory space for a system program to store all execution instructions. The extra memory 202 is used as a memory space to store general information, such as information from the optical disk 100.

In general, when the computer 216 is turned on or reset, the microprocessor 204 first initializes the optical disk system, and stays at queue status to receive a command from the computer 216 so as to start to read information from the optical disk 100. When the computer 216 sends the command to request a read, the microprocessor 204 then sends desired parameters out to control the controller 208 and the decoder 206 so as to drive a motor and an optical pickup head (not shown) to read information of the optical disk 100. The information of the optical disk 100 is decoded and corrected, if it is necessary, by the decoder 206 and then is stored in the buffer memory 212. The computer 216 can therefore read the information stored in the buffer memory 212 through the main board interface 214 and the decoder 206. At this stage, the extra memory 202 is used to store general information, and the flash memory 210 is used to store the system program, which is used to operate the optical disk system.

In an update programming mode, the optical disk system needs to update firmware information. An update program can be installed into the optical disk system by reading the update program off of the optical disk 100, or by executing special installation software that has been downloaded onto the computer 216. The update program includes a program code, and an update program routine. The program code is treated as data that is to be updated. The update program, usually, will issue a flash memory command to update the flash memory 210. In this update mode, the extra memory 202 is used to store the update program routine, and the program code data is first stored in the buffer memory 212.

The microprocessor 204 reads instructions, which reside in the update program routine, from the extra memory 202 and executes the instructions. The program code data stored in the buffer memory 212 is sequentially written into the flash memory 210, which serves as a memory space for the program code data. Here, the program code is treated as data of the firmware information to be updated. A checksum of the program code data from the buffer memory 212 is calculated and compared with a checksum of the program code written into the flash memory 210 to check for errors occurring during the writing process. After the firmware in the flash memory 210 is updated, the system program information residing in the firmware is executed.

For a concise summary of the above description, please refer to FIG. 2. FIG. 2 is a flowchart illustrating the firmware updating procedure according to the prior art.

Step 300:

Determine if the updated firmware resides on the optical disk 100 or on an external source such as the computer 216; if the firmware is on the optical disk 100, go to step 302; if not, go to step 304;

Step 302:

Copy the program code from the optical disk 100 to the buffer memory 212, and copy the update program routine from the optical disk 100 to the extra memory 202; at this point, the microprocessor 204 treats the flash memory 210 as data access memory and treats the extra memory 202 as execution program memory; go to step 306;

Step 304:

Copy the program code from the external source to the buffer memory 212, and copy the update program routine from the external source to the extra memory 202; at this point, the microprocessor 204 treats the flash memory 210 as data access memory and treats the extra memory 202 as execution program memory; and

Step 306:

Execute the update program routine stored in the extra memory 202; this writes the program code stored in the buffer memory 212 into the flash memory 210 in order to update the firmware information stored in the flash memory 210; the flash memory 210 is then treated as execution program memory the extra memory 202 is treated as data access memory, and the system program information residing in the flash memory 210 is executed.

Please refer to FIG. 3. FIG. 3 is a block diagram illustrating a transition of switching from execution of the update program routine stored in the extra memory 202 to execution of the system program information stored in the flash memory 210. As just stated in step 306, the update program routine stored in the extra memory 202 is executed by the microprocessor 204 in order to write the program code stored in the buffer memory 212 into the flash memory 210. After successful execution of the update program routine, the firmware in the flash memory 210 is updated. The microprocessor 204 then switches from executing the update program routine located in the extra memory 202 to executing the system program information stored in the flash memory 210.

Unfortunately, after the switch, a program counter of the microprocessor 204 may contain a value that would not allow for a smooth transition from execution of the update program routine located in the extra memory 202 to execution of the system program located in the flash memory 210, and the microprocessor 204 may begin executing code located in a problem area 260 of the flash memory 210. This problem could occur if the new firmware information stored in the flash memory 210 is of a different length than the old firmware information. For example, suppose that immediately after updating the firmware in the flash memory 210, the microprocessor 204 was supposed to execute a “jump” or “return” statement in the firmware. However, since the firmware has now been updated, an “if” statement now resides where the “jump” or “return” statement used to be. This changed area of the flash memory 210 where the microprocessor 204 will execute from is labeled as the problem area 260 in FIG. 3. The area immediately preceding the problem area is labeled as a kernel area 250. When the microprocessor 204 executes firmware instructions located in the problem area 260, unknown consequences may occur, and the microprocessor 204 may fail to execute properly.

### SUMMARY OF INVENTION

It is therefore a primary objective of the claimed invention to provide a method for updating firmware information of an optical disk system in order to solve the above-mentioned problems.

According to the claimed invention, an update method is used in an optical disk system to update firmware information stored in a firmware memory. The method includes fetching program code and an update program routine from an update source, storing the program code into a first buffer, storing the update program routine into a second buffer, executing the update program routine stored in the second buffer, and using the update program routine to write the program code stored in the first buffer into the firmware memory to update the firmware information, changing a value of a program counter of the microprocessor such that the microprocessor executes the program code stored in the firmware memory at a predetermined location of the program code instead of executing a next instruction in the program code located after the current position of the program counter, and using the program code as updated firmware information to control the optical disk system.

It is an advantage of the claimed invention that the value of the program counter of the microprocessor is changed so that the microprocessor can execute program code located at the predetermined location of the firmware instead of executing the next instruction. This will prevent the microprocessor from executing unknown instructions located in the middle of the newly updated firmware that could cause the microprocessor to stop working properly, and instead will allow the microprocessor to begin executing from a known location in the firmware.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of an optical disk system and its periphery units according to the prior art.

FIG. 2 is a flowchart illustrating a firmware updating procedure according to the prior art.

FIG. 3 is a block diagram illustrating a transition of switching from execution of an update program routine stored in an extra memory to execution of system program information stored in a flash memory according to the prior art.

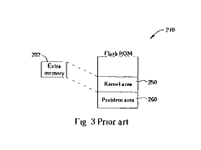

FIG. 4 is a block diagram of an optical disk system according to the present invention.

FIG. 5 is a flowchart illustrating a method of updating firmware in an optical disk system according to the present invention.

FIG. 6 is a block diagram illustrating control circuitry that is used to provide a reset signal to a microprocessor of the optical disk system of the present invention.

FIG. 7 is a timing diagram showing a relationship between control signals used in the control circuitry.

### DETAILED DESCRIPTION

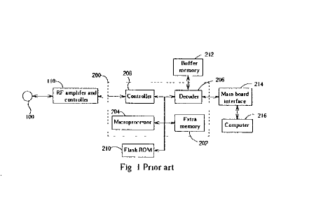

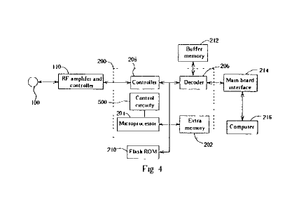

Please refer to FIG. 4. FIG. 4 is a block diagram of an optical disk system according to the present invention. The optical disk system shown in FIG. 4 is identical to the optical disk system shown in FIG. 1 except for the addition of control circuitry 500. The control circuitry 500 is connected to the microprocessor 204 to help control operation of the microprocessor 204, as will be thoroughly explained below. Since all other components are the same, the reference numbers used in FIG. 4 and in the following description will be the same numbers used in FIG. 1.

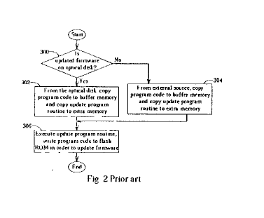

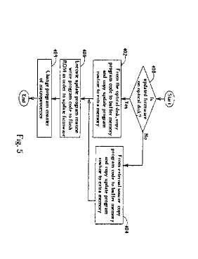

Please refer to FIG. 5. FIG. 5 is a flowchart illustrating a method of updating firmware in an optical disk system according to the present invention. Notice that all steps in the flowchart are identical to the steps in the prior art method shown in FIG. 2 except for a new step 408.

Step 400:

Determine if the updated firmware resides on the optical disk 100 or on an external source such as the computer 216; if the firmware is on the optical disk 100, go to step 402; if not, go to step 404;

Step 402:

Copy the program code from the optical disk 100 to the buffer memory 212, and copy the update program routine from the optical disk 100 to the extra memory 202; at this point, the microprocessor 204 treats the flash memory 210 as data access memory and treats the extra memory 202 as execution program memory; go to step 406;

Step 404:

Copy the program code from the external source to the buffer memory 212, and copy the update program routine from the external source to the extra memory 202; at this point, the microprocessor 204 treats the flash memory 210 as data access memory and treats the extra memory 202 as execution program memory;

Step 406:

Execute the update program routine stored in the extra memory 202; this writes the program code stored in the buffer memory 212 into the flash memory 210 in order to update the firmware information stored in the flash memory 210; the flash memory 210 is then treated as execution program memory the extra memory 202 is treated as data access memory; and

Step 408:

Change a value of the program counter of the microprocessor 204 such that the microprocessor 204 executes the program code stored in the flash memory 210 at a predetermined location of the program code instead of executing a next instruction in the program code located after the current position of the program counter; the system program information residing at the predetermined location of the flash memory 210 is executed in order to control the optical disk system.

As can be seen from the flowchart in FIG. 5, the present invention method adds an additional step (step 408) to the firmware updating method of the prior art. This step involves changing the value of the program counter of the microprocessor 204, which is preferably accomplished by resetting the microprocessor 204 after successfully storing the updated firmware in the flash memory 210. Resetting the microprocessor 204 will automatically reset the program counter of the microprocessor 204 back to a predetermined value, and will allow the microprocessor 204 to start executing instructions in the firmware from a predetermined starting location.

Besides resetting the microprocessor 204, another way of changing the value of the program counter is by having the microprocessor 204 execute a “jump” or “return” statement that would change the program counter of the microprocessor 204 to a predetermined value, which could also be the same predetermined value that would be used if the microprocessor 204 was reset. By executing the “jump” or “return” statement after switching the program source of microprocessor 204 from the extra memory 202 to the flash memory 210, the microprocessor 204 can start to execute instructions in the firmware from a predetermined starting location. However, this method can only be executed when the “jump” or “return” statement in the extra memory 202 is located in the same address as the “jump” or “return” statement in the flash memory 210 (program counters have the same value). Concerns regarding the use of the “jump” or “return” statement in the present invention are the same concerns present in the prior art. Since the prior art did not use the hardware method to change program counter to the predetermined value, the firmware has to use the “jump” or “return” method. Moreover, the programmer who develops the firmware should take notice of this issue, otherwise, the program counter will contain an unexpected value after the program source of microprocessor 204 switches from the extra memory 202 to the flash memory 210. In general, the programmer should confirm that after updating the firmware in the flash memory 210, the kernel area 250 is same as the program in the extra memory 202. This is the easiest way to make sure that the address of the “jump” or “return” statement is the same in the extra memory 202 and the flash memory 210.

Each of these techniques for changing the program counter of the microprocessor 204 will prevent the problem of the prior art method from occurring. That is, instead of having the microprocessor 204 execute unknown instructions in the flash memory 210 after the firmware is updated, the microprocessor 204 can instead begin executing instructions from a known, predetermined location of the updated firmware. On the other hand, the prior art method requires the use of the “jump” or “return” method, and the programmer needs to pay special attention to write the update program subroutine very carefully. Therefore, by using the present invention method, the microprocessor 204 will not stop working properly as a result of executing unknown instructions, even if the update program subroutine is different from the information stored in the kernel area 250 of the firmware memory 210 after a successful firmware update.

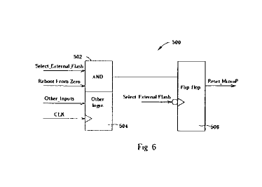

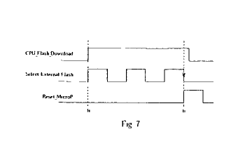

Please refer to FIG. 6 and FIG. 7. FIG. 6 is a block diagram illustrating the control circuitry 500 that is used to provide a reset signal Reset_MicroP to the microprocessor 204 of the optical disk system of the present invention. FIG. 7 is a timing diagram showing a relationship between control signals used in the control circuitry 500. Two control signals, a Select_External_Flash signal and a Reboot_From_Zero signal, are used to trigger the Reset_MicroP signal that is used to reset the microprocessor 204. The Select_External_Flash signal is active each time the microprocessor 204 accesses the flash memory 210, and each time the microprocessor 204 writes updated firmware into the flash memory 210.

As shown in FIG. 7, when the microprocessor 204 begins writing the updated firmware into the flash memory 210 at time t0, a CPU_Flash_Download signal is active, and the Select_External_Flash signal is triggered each time the microprocessor 204 accesses the flash memory 210 in order to write the new firmware into the flash memory 210. The Reboot_From_Zero signal is automatically activated by the update program routine that the microprocessor 204 executes during the update process. The Reboot_From_Zero signal can be given a value of “1” after an n^{th} access to the flash memory 210 as indicated by the Select_External_Flash signal, or can be given the value of “1” when the microprocessor makes its last access to the flash memory 210 during the process of updating the firmware.

As can be seen in FIG. 6, the control circuitry 500 contains an AND gate 502 that receives the Select_External_Flash signal and the Reboot_From_Zero signal. When these two signals both have a value equal to “1”, a value of “1” is outputted from the AND gate 502 into a flip-flop 506. As shown at time t1 of FIG. 7, the flip-flop 506 receives the input value when a negative edge of the Select_External_Flash signal is received by a clock input of the flip-flop 506. The flip-flop 506 then outputs the Reset_MicroP signal, which is used to reset the microprocessor 204.

In addition to the two input signals Select_External_Flash and Reboot_From_Zero, other input signals can be used with the control circuitry 500 as well. As shown in FIG. 6, other logic circuitry 504 can be used to receive other control signals Other_Inputs and a clock CLK. Using the other logic circuitry 504, additional conditions and control circuitry can be used in order to generate the Reset_MicroP signal for resetting the microprocessor 204. Use of the clock CLK makes the control circuitry 500 a synchronous design. Instead, the control circuitry could be made asynchronous by replacing the clock CLK signal with a handshaking signal used by the microprocessor 204 to handshake with the flash memory 210.

Compared to the prior art method of updating firmware information of an optical disk system, the present method ensures that the microprocessor of the optical disk system will be able to function normally after the update. This is accomplished by either resetting the microprocessor or by executing a “jump” (or “return”) statement. In each case, the program counter of the microprocessor will start executing code from a predetermined location of the firmware stored in the flash memory, and will not begin executing unknown code as was done with the prior art.

Those skilled in the art will readily observe that numerous modifications and alterations of the device may be made while retaining the teachings of the invention. Accordingly, the above disclosure should be construed as limited only by the metes and bounds of the appended claims.

what is claimed is:

1. An update method used in an optical disk system to update firmware information, which is stored in a firmware memory, using a microprocessor, wherein the firmware memory serves as an intrinsic execution program memory, the method comprising steps:
fetching a program code and an update program routine from an update source;
storing the program code into a first buffer memory, and storing the update program routine into a second buffer memory, wherein the microprocessor accesses the firmware memory as a data access memory, and accesses the second buffer memory as an execution program memory;
executing the update program routine stored in the second buffer memory, and using the update program routine to write the program code stored in the first buffer memory into the firmware memory in order to update the firmware information;
accessing the firmware memory as intrinsic execution program memory, and accessing the second buffer memory as intrinsic data access memory;
changing a value of a program counter of the microprocessor such that the microprocessor executes the program code stored in the firmware memory at a predetermined location of the program code instead of executing a next instruction in the program code located after the current position of the program counter; and
using the program code as updated firmware information to control the optical disk system.

2. The method of claim 1 wherein changing the value of the program counter of the microprocessor is performed by resetting the microprocessor, which will reset the program counter of the microprocessor to a predetermined value.

3. The method of claim 1 wherein changing the program counter of the microprocessor is performed by executing a jump statement in the program code of the updated firmware information, and the jump statement will reset the program counter of the microprocessor to a predetermined value.

4. The method of claim 1 wherein the update source, which the program code is fetched from, is an optical disk read by the optical disk system, and the update program routine is fetched from the optical disk read by the optical disk system or from original contents of the flash memory.

5. The method of claim 4 wherein the optical disk is a compact disk, and the optical disk system is a compact disk drive.

6. The method of claim 1 wherein the update source, which the program code is fetched from, is a peripheral device connected to the optical disk system through an interface connection, and the update program routine is fetched from the peripheral device connected to the optical disk system through the interface connection or from original contents of the flash memory.

7. The method of claim 6 wherein the peripheral device is a computer, onto which the program code and the update program routine have been downloaded from a software source.

8. The method of claim 6 wherein the interface connection is an IDE interface, an EIDE interface, a SCSI interface, an RS232 interface, a USB interface, or an IEEE 1394 interface.

9. The method of claim 1, wherein the firmware memory is a flash memory.

10. The method of claim 1, wherein the firmware memory is an electrically erasable programmable read only memory (EEPROM).

11. An optical disk system control chip, used in an optical disk system to update firmware information, the control chip comprising:
a microprocessor, coupled to a data bus, wherein the microprocessor is also coupled to a firmware memory through the data bus, in which the firmware memory is used to store the firmware information;
a decoder, coupled to the microprocessor through the data bus, wherein the decoder is also coupled to a first buffer memory, and the decoder receives updated firmware information from an update source;
a controller, coupled to the decoder, and coupled to the microprocessor through the data bus, wherein the controller is used to receive a control signal and general data; and
a second buffer memory, coupled to the microprocessor through the data bus, wherein when the optical disk system is operated in an update mode, the microprocessor accesses the firmware memory as a data access memory and accesses the second buffer memory as an execution program memory, and after the firmware is completely updated, the second buffer memory is accessed as data access memory and the firmware memory is accessed as execution program memory, and a value of a program counter of the microprocessor is changed such that the microprocessor executes program code stored in the firmware memory at a predetermined location of the program code instead of executing a next instruction in the program code located after the current position of the program counter.

12. The control chip of claim 11 wherein the control chip further comprises a control circuit used for generating a reset signal, and changing the value of the program counter of the microprocessor is performed by the control circuit issuing the reset signal to the microprocessor, which will reset the program counter of the microprocessor to a predetermined value.

13. The control chip of claim 11 wherein changing the program counter of the microprocessor is performed by executing a jump statement in the program code of the updated firmware information, and the jump statement will reset the program counter of the microprocessor to a predetermined value.

14. The control chip of claim 11 wherein the update source, which the updated firmware information is fetched from, is an optical disk read by the optical disk system.

15. The control chip of claim 14 wherein the optical disk is a compact disk, and the optical disk system is a compact disk drive.

16. The control chip of claim 11 wherein the update source, which the updated firmware information is fetched from, is a peripheral device connected to the optical disk system through an interface connection.

17. The control chip of claim 16 wherein the peripheral device is a computer, onto which the program code and the update program routine have been downloaded from a software source.

18. The control chip of claim 16 wherein the interface connection is an IDE interface, an EIDE interface, a SCSI interface, an RS232 interface, a USB interface, or an IEEE 1394 interface.

19. The control chip of claim 11, wherein the firmware memory is a flash memory.

20. The control chip of claim 11, wherein the firmware memory is an electrically erasable programmable read only memory (EEPROM).
